(19) United States
(12) Patent Application Publication
(10) Pub. No.: US 2025/0246173 A1
(43) Pub. Date: Jul. 31, 2025

(54) Adjustable Wind Chime Gong Device

(71) Applicant: James Cancienne, Walker, LA (US)

(72) Inventor: James Cancienne, Walker, LA (US)

(21) Appl. No.: 18/769,636

(22) Filed: Jul. 11, 2024

Related U.S. Application Data
(60) Provisional application No. 63/625,006, filed on Jan. 25, 2024.

(51) Int. Cl. G10K 1/072

(52) U.S. Cl. CPC G10K 1/072

(57) ABSTRACT

An adjustable wind chime device is disclosed that is a regular set of wind chimes with a gong attached in the middle of the chimes. Specifically, the adjustable wind chime device comprises a plurality of chime components suspended by lines and secured to a base component, which allows the plurality of chime components to hang in a vertical configuration. The device also comprises a gong component suspended by a line and secured to the base component, positioned in the middle of the chime components. Further, a rubber ball is positioned under the gong component, which will allow the user to change the sounds emitted from the wind chimes, as well as silence them with ease. The rubber ball is secured to the gong component via a small hole drilled into the ball and a line is attached with glue.

### CROSS-REFERENCE TO RELATED APPLICATION

The present application claims priority to, and the benefit of, U.S. Provisional Application No. 63/625,006, which was filed on Jan. 25, 2024, and is incorporated herein by reference in its entirety.

### FIELD OF THE INVENTION

The present invention relates generally to the field of adjustable wind chime devices. More specifically, the present invention relates to improved wind chimes that can have their tone or volume adjusted. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in adjustable wind chime devices. Generally, people may enjoy installing wind chimes on their decks and patios. However, standard wind chimes can get boring after a period of time. Accordingly, people may be looking for new and unique sounds and decorations to add to their patios and decks.

Generally, many people enjoy the sounds of a wind chime outside of their home or business. Wind chimes can produce a calming and relaxing melody on a windy day. Because of the long existence of wind chimes, there has been a greater variance of wind chime design and function that has grown over time. Today, wind chimes are used inside and outside and users may desire for adjustable sounds without buying new wind chimes.

Accordingly, there is a demand for an improved adjustable wind chime device that allows users to adjust their tone or volume. More particularly, there is a demand for an adjustable wind chime device that can be silenced with ease.

Therefore, there exists a long felt need in the art for an adjustable wind chime device that provides users with improved wind chimes that can have their tone or volume adjusted. There is also a long felt need in the art for an adjustable wind chime device that features a rubber ball underneath the gong that changes sounds emitted from the chimes. Further, there is a long felt need in the art for an adjustable wind chime device that can function as a way to silence the wind chimes with ease. Moreover, there is a long felt need in the art for a device that offers a simple means for adjusting the sound of wind chimes. Further, there is a long felt need in the art for an adjustable wind chime device that secures the rubber ball via string and glue. Finally, there is a long felt need in the art for an adjustable wind chime device that is available in different sizes and styles.

The subject matter disclosed and claimed herein, in one embodiment thereof, comprises an adjustable wind chime device. The device is a regular set of wind chimes with a gong attached in the middle of the chimes. The adjustable wind chime device comprises a plurality of chime components suspended by lines and secured to a base component, which allows the plurality of chime components to hang in a vertical configuration. The device also comprises a gong component suspended by a line and secured to the base component, positioned in the middle of the chime components. Further, a rubber ball is positioned under the gong component, which will allow the user to change the sounds emitted from the wind chimes, as well as silence them with ease. The rubber ball is secured to the gong component via a small hole drilled into the ball and a line is attached with glue.

In this manner, the adjustable wind chime device of the present invention accomplishes all of the forgoing objectives and provides users with a device that allows users to adjust their tone or volume of the chimes. The device is a set of wind chimes with a rubber ball secured below the gong component. The device can be available in different sizes and styles.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an adjustable wind chime device. The device is a regular set of wind chimes with a gong attached in the middle of the chimes. The adjustable wind chime device comprises a plurality of chime components suspended by lines and secured to a base component, which allows the plurality of chime components to hang in a vertical configuration. The device also comprises a gong component suspended by a line and secured to the base component, positioned in the middle of the chime components. Further, a rubber ball is positioned under the gong component, which will allow the user to change the sounds emitted from the wind chimes, as well as silence them with ease.

Generally, wind chimes produce soft pleasing sounds when blown by the wind. Further, typical wind chimes include several chime components in the form of metal tubes suspended vertically from a base component. The chime components are suspended so that they are free to swing about the base component. A striker or gong component is included that is responsive to the wind (i.e., air moving past the wind chimes). When the gong component moves, it impacts the metal tubes as they swing about to produce gentle chiming sounds.

In one embodiment, the adjustable wind chime device comprises a base component that is configured in a circular shape, but can be any suitable shape as is known in the art, such as square, rectangular, oval, etc. The base component comprises an upper portion and a lower portion. The base component can be hollow or solid. The base component provides a structure by which the other components are attached. In one embodiment, the base component is a circular configuration with a hollow middle (i.e., shaped like a doughnut).

In one embodiment, the base component comprises a hanger extending upward from the upper portion. In the shown embodiment, the hanger is a cord configured to provide a loop configured to receive a securing means (i.e., a thumb tack, pushpin, nail, screw, etc.) therein and suspend the adjustable wind chime device therefrom. In another embodiment, the hanger is a hook that interacts with a rod or other structural device. The hanger is any suitable structure for hanging the adjustable wind chime device in a way that would allow free hanging and movement of the components.

In one embodiment, the adjustable wind chime device comprises a plurality of chime components. Typically, the chime components are configured as cylindrical metal tubes of varying sizes, suspended vertically from the base component, but can be any suitable size and shape as is known in the art. Each chime component of the plurality of chime components is secured to the lower portion of the base component by at least one chime support cord or line. In one embodiment, the plurality of chime components are secured to the lower portion in a circular arrangement. Each of the chime components is configured to produce an audible noise when struck. In one embodiment, the chime components are hollow. Each of the chime components is made from a material configured to produce audible sound when struck. The chime support cords are any lines configured to support a chime component and adapted to allow each of the chime components to be struck. In one embodiment, the chime support cords are metal cords configured to attach to each of the plurality of chime components to the lower portion by a single connection point on a proximate end of each of the plurality of chime components.

In one embodiment, a clapper or gong component is secured to the lower portion by a clapper support cord. The gong component is centrally located relative to the plurality of chime components. The gong component is configured to strike the plurality of chime components. In one embodiment, the gong component is connected to a wind catch. Under this embodiment, when the wind catch is moved by a wind, the gong component will be moved because of the connection with the wind catch to strike one or more of the plurality of chime components. The gong component is made of a material adapted to strike a chime component and produce audible sound. The clapper support cord is a line adapted to support a gong component in a manner that permits the gong component to strike the plurality of chime components. In one embodiment, the clapper support cord is connected to a central point of the lower portion relative to the plurality of chime components.

In one embodiment, the gong component is a disc-shaped piece of material having an upwardly facing surface which comprises a line to attach it to the base component by suitable means (i.e., glue) and a downwardly facing surface beneath which the ball component is disposed and secured. However, the gong component can be most any shape, a rectangular, square, triangular, etc. The shape of the gong component contributes to the variations of tone (i.e., the tone-varying effect) as it contacts the plurality of chime components. The gong component can be fabricated from a range and combination of materials including wood, metal, rawhide, felt, plastic, hard rubber, etc., each having its own qualities of sound. Variations of size and weight will also affect performance and should be considered in combination with the ball component to produce a desired movement and impact. Any of many other shapes may be used, such as pentagons, hexagons, and octagons, etc. A round gong component may also be employed, but it will not produce the variation in sound of the multi-sided versions.

In one embodiment, a ball component is secured distally from the gong component. Specifically, the ball component is positioned under the gong component, which will allow the user to change the sounds emitted from the plurality of chime components, as well as silence them with ease. For example, the ball component functions as a means for causing the gong component to rotate in response to the wind moving past the ball component and/or the gong component in order to thereby vary the tone (i.e., produce a tone-varying effect). The ball component is secured to the gong component via a small hole drilled into the ball component and a line attached with glue. Further, the ball component is typically manufactured of rubber, or other polymers, but can be manufactured of any suitable material as is known in the art. Although simple in appearance, design of the ball component is important. The ball component performs multiple functions, as it provides for the adjustment of the tone or volume of the plurality of chime components and/or it provides for a means to effectively silence the plurality of wind chimes with ease.

In one embodiment, the line is a first length of flexible line (i.e., monofilament fishing line) is connected to a separate support structure (i.e., a tree limb) and to the base component via a swivel (i.e., a fishing line swivel). Part of the first length of flexible line extends between the support structure and the swivel, while another part extends between the swivel and the base component. So connected, the first length of flexible line functions as means for supporting the device from the support structure so that the base component, the plurality of chime components, and/or the gong component are free to rotate about a rotational axis in response to the wind.

In one embodiment, a second length of flexible line (i.e., monofilament fishing line) is connected to the gong component and to the underside of the base component, while a third length of flexible line (not shown) is connected to the gong component and the ball component. The second length of flexible line functions as means for supporting the gong component while allowing rotational and sideways movement of the plurality of chime components in response to the wind. The second and third lengths of flexible line also function as means for storing rotational energy as the gong component and/or ball component rotate. Thus, the gong component and/or the ball component rotate while the plurality of chime components rotate and swing about. This combination of actions causes the ball component to impact the gong component in unpredictable ways to produce the different chiming sounds desired from the plurality of chime components.

In yet another embodiment, the adjustable wind chime device comprises a plurality of indicia.

In yet another embodiment, a method of adjusting the tone and volume of a set of wind chimes is disclosed. The method includes the steps of providing an adjustable wind chime device comprising a plurality of chime components and a gong component which are suspended by lines and secured to a base component in a vertical configuration. The method also comprises drilling a small hole into a ball component. Further, the method comprises securing a line via glue to the hole to suspend the ball component under the gong component. Finally, the method comprises adjusting the ball component to change the sounds emitted or to silence the chimes.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the adjustable wind chime device of the present invention in accordance with the disclosed architecture;

FIG. 2 illustrates a perspective view of one embodiment of the adjustable wind chime device of the present invention showing the ball component in accordance with the disclosed architecture;

FIG. 3 illustrates a perspective view of one embodiment of the adjustable wind chime device of the present invention showing the ball secured to the gong component in accordance with the disclosed architecture;

FIG. 4 illustrates a perspective view of one embodiment of the adjustable wind chime device of the present invention showing the device in use in accordance with the disclosed architecture; and

FIG. 5 illustrates a flowchart showing the method of adjusting the tone and volume of a set of wind chimes in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an adjustable wind chime device that provides users with improved wind chimes that can have their tone or volume adjusted. There is also a long felt need in the art for an adjustable wind chime device that features a rubber ball underneath the gong that changes sounds emitted from the chimes. Further, there is a long felt need in the art for an adjustable wind chime device that can function as a way to silence the wind chimes with ease. Moreover, there is a long felt need in the art for a device that offers a simple means for adjusting the sound of wind chimes. Further, there is a long felt need in the art for an adjustable wind chime device that secures the rubber ball via string and glue. Finally, there is a long felt need in the art for an adjustable wind chime device that is available in different sizes and styles.

The present invention, in one exemplary embodiment, is a novel adjustable wind chime device. The adjustable wind chime device comprises a plurality of chime components suspended by lines and secured to a base component, which allows the plurality of chime components to hang in a vertical configuration. The device also comprises a gong component suspended by a line and secured to the base component, positioned in the middle of the chime components. Further, a rubber ball is positioned under the gong component, which will allow the user to change the sounds emitted from the wind chimes, as well as silence them with ease. The rubber ball is secured to the gong component via a small hole drilled into the ball and a line is attached with glue. The present invention also includes a novel method of adjusting the tone and volume of a set of wind chimes. The method includes the steps of providing an adjustable wind chime device comprising a plurality of chime components and a gong component which are suspended by lines and secured to a base component in a vertical configuration. The method also comprises drilling a small hole into a ball component. Further, the method comprises securing a line via glue to the hole to suspend the ball component under the gong component. Finally, the method comprises adjusting the ball component to change the sounds emitted or to silence the chimes.

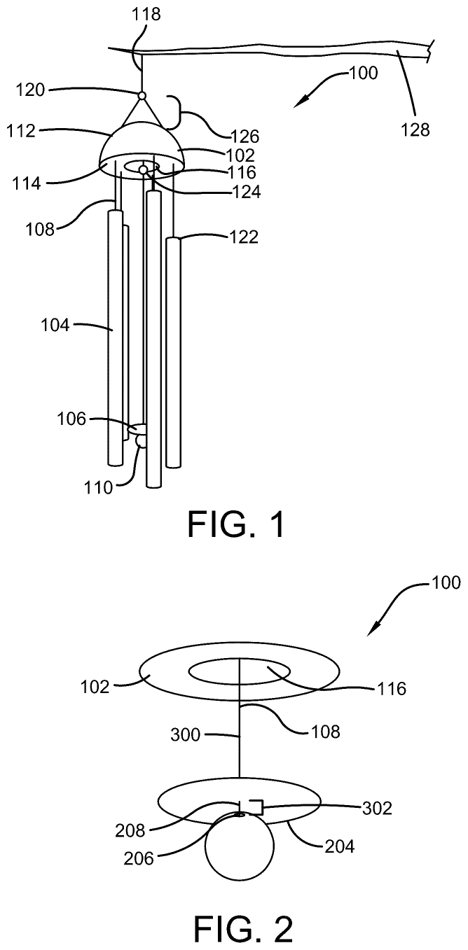

Referring initially to the drawings, FIG. 1 illustrates a perspective view of one embodiment of the adjustable wind chime device 100 of the present invention. In the present embodiment, the adjustable wind chime device 100 is an improved adjustable wind chime device 100 that provides a user with wind chimes that can have their tone or volume adjusted. Specifically, the adjustable wind chime device 100 comprises a base component 102 with a plurality of chime components 104 and a gong component 106 secured in a vertical configuration via lines 108. Further, a rubber ball 110 is positioned under the gong component 106, which will allow the user to change the sounds emitted from the wind chimes 104, as well as silence them with ease.

Generally, wind chimes produce soft pleasing sounds when blown by the wind. Further, typical wind chimes include several chime components 104 in the form of metal tubes suspended vertically from a base component 102. The chime components 104 are suspended so that they are free to swing about the base component 102. A striker or gong component 106 is included that is responsive to the wind (i.e., air moving past the wind chimes 104). When the gong component 106 moves, it impacts the metal tubes as they swing about to produce gentle chiming sounds.

Furthermore, the adjustable wind chime device 100 comprises a base component 102 that is configured in a circular shape, but can be any suitable shape as is known in the art, such as square, rectangular, oval, etc. The base component 102 comprises an upper portion 112 and a lower portion 114. The base component 102 can be hollow or solid. The base component 102 provides a structure by which the other components are attached. In one embodiment, the base component 102 is a circular configuration with a hollow middle 116 (i.e., shaped like a doughnut).

Additionally, the base component 102 comprises a hanger 118 extending upward from the upper portion 112. In the shown embodiment, the hanger 118 is a cord configured to provide a loop 120 configured to receive a securing means (i.e., a thumb tack, pushpin, nail, screw, etc.) therein and suspend the adjustable wind chime device 100 therefrom. In another embodiment, the hanger 118 is a hook that interacts with a rod or other structural device. The hanger 118 is any suitable structure for hanging the adjustable wind chime device 100 in a way that would allow free hanging and movement of the components.

Further, the adjustable wind chime device 100 comprises a plurality of chime components 104. Typically, the chime components 104 are configured as cylindrical metal tubes of varying sizes, suspended vertically from the base component 102, but can be any suitable size and shape as is known in the art, depending on the needs and/or wants of a user. Each chime component 104 of the plurality of chime components 104 is secured to the lower portion 114 of the base component 102 by at least one chime support cord or line 108. In one embodiment, the plurality of chime components 104 are secured to the lower portion 114 in a circular arrangement, but can be secured in any suitable arrangement as is known in the art. Each of the chime components 104 is configured to produce an audible noise when struck. In one embodiment, the chime components 104 are hollow. Each of the chime components 104 is made from a material configured to produce an audible sound when struck. The chime support cords 108 are any lines configured to support a chime component 104 and adapted to allow each of the chime components 104 to be struck. In one embodiment, the chime support cords 108 are metal cords configured to attach to each of the plurality of chime components 104 to the lower portion 114 by a single connection point on a proximate end 122 of each of the plurality of chime components 104.

Additionally, the chime support cords 108 or lines include a first length 126 of flexible line (i.e., monofilament fishing line) connected to a separate support structure 128 (i.e., a tree limb) and to the base component 102 via a swivel 124 (i.e., a fishing line swivel). Part of the first length 126 of flexible line 108 extends between the support structure 128 and the swivel 124, while another part extends between the swivel 124 and the base component 102. So connected, the first length 126 of flexible line 108 functions as means for supporting the device 100 from the support structure 128 so that the base component 102, the plurality of chime components 104, and/or the gong component 106 are free to rotate about a rotational axis in response to the wind.

As shown in FIG. 2, a clapper or gong component 106 is secured to the lower portion 114 by a clapper support cord 108. The gong component 106 is centrally located relative to the plurality of chime components 104. The gong component 106 is configured to strike the plurality of chime components 104. In one embodiment, the gong component 106 is connected to a wind catch 200. Under this embodiment, when the wind catch 200 is moved by a wind, the gong component 106 will be moved because of the connection with the wind catch 200 to strike one or more of the plurality of chime components 104. The gong component 106 is made of a material adapted to strike a chime component 104 and produce audible sound. The clapper support cord 108 is a line adapted to support a gong component 106 in a manner that permits the gong component 106 to strike the plurality of chime components 104. In one embodiment, the clapper support cord 108 is connected to a central point of the lower portion 114 relative to the plurality of chime components 104.

Furthermore, the gong component 106 is a disc-shaped piece of material having an upwardly facing surface 202 which comprises a line 108 to attach it to the base component 102 by suitable means (i.e., glue) and a downwardly facing surface 204 beneath which the ball component 110 is disposed and secured. However, the gong component 106 can be most any shape, a rectangular, square, triangular, etc. The shape of the gong component 106 contributes to the variations of tone (i.e., the tone-varying effect) as it contacts the plurality of chime components 104. The gong component 106 can be fabricated from a range and combination of materials including wood, metal, rawhide, felt, plastic, hard rubber, etc., each having its own qualities of sound. Variations of size and weight will also affect performance and should be considered in combination with the ball component 110 to produce a desired movement and impact. Any of many other shapes may be used, such as pentagons, hexagons, and octagons, etc. A round gong component 106 may also be employed, but it will not produce the variation in sound of the multi-sided versions.

Additionally, a ball component 110 is secured distally from the gong component 106. Specifically, the ball component 110 is positioned under the gong component 106, which will allow the user to change the sounds emitted from the plurality of chime components 104, as well as silence them with ease. For example, the ball component 110 functions as a means for causing the gong component 106 to rotate in response to the wind moving past the ball component 110 and/or the gong component 106 in order to thereby vary the tone (i.e., produce a tone-varying effect). The ball component 110 is secured to the gong component 106 via a small hole 206 drilled into the ball component 110 and a line 208 attached with glue or other securing means as is known in the art. Further, the ball component 110 is typically manufactured of rubber, or other polymers, but can be manufactured of any suitable material as is known in the art. Although simple in appearance, design of the ball component 110 is important. The ball component 110 performs multiple functions, as it provides for the adjustment of the tone or volume of the plurality of chime components 104 and/or it provides for a means to effectively silence the plurality of wind chimes 104 with ease.

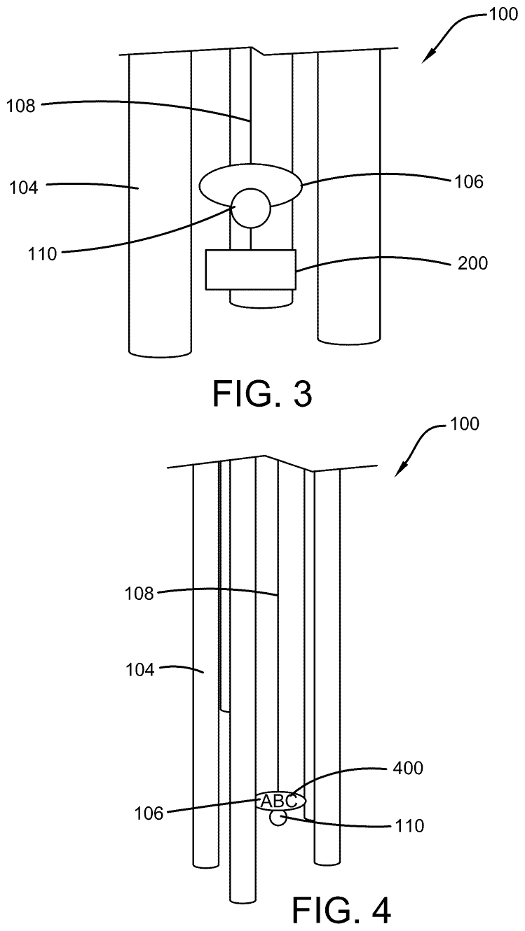

As shown in FIG. 3, a second length 300 of flexible line 108 (i.e., monofilament fishing line) is connected to the gong component 106 and to the underside 114 of the base component 102, while a third length 302 of flexible line 108 (not shown) is connected to the gong component 106 and the ball component 110. The second length 300 of flexible line 108 functions as means for supporting the gong component 106 while allowing rotational and sideways movement of the plurality of chime components 104 in response to the wind. The second 300 and third 302 lengths of flexible line 108 also function as means for storing rotational energy as the gong component 106 and/or ball component 110 rotate. Thus, the gong component 106 and/or the ball component 110 rotate while the plurality of chime components 104 rotate and swing about. This combination of actions causes the ball component 110 to impact the gong component 106 in unpredictable ways to produce the different chiming sounds desired from the plurality of chime components 104.

As shown in FIG. 4, the adjustable wind chime device 100 comprises a plurality of indicia 400. The base component 102 of the device 100 may include advertising, a trademark, or other letters, designs, or characters, printed, painted, stamped, or integrated into the base component 102, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be wind chime, gong, or brand related.

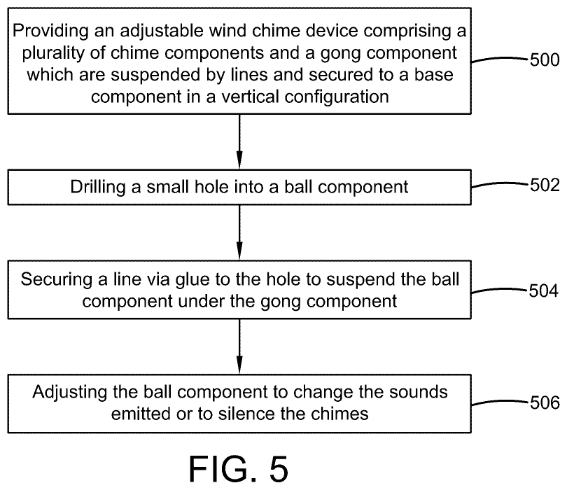

FIG. 5 illustrates a flowchart of the method of adjusting the tone and volume of a set of wind chimes. The method includes the steps of at 500, providing an adjustable wind chime device comprising a plurality of chime components and a gong component which are suspended by lines and secured to a base component in a vertical configuration. The method also comprises at 502, drilling a small hole into a ball component. Further, the method comprises at 504, securing a line via glue to the hole to suspend the ball component under the gong component. Finally, the method comprises at 506, adjusting the ball component to change the sounds emitted or to silence the chimes.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “adjustable wind chime device”, “wind chime device”, “adjustable device”, and “device” are interchangeable and refer to the adjustable wind chime device 100 of the present invention.

Notwithstanding the forgoing, the adjustable wind chime device 100 of the present invention can be of any suitable size and configuration as is known in the art without affecting the overall concept of the invention, provided that it accomplishes the above stated objectives. One of ordinary skill in the art will appreciate that the adjustable wind chime device 100 as shown in FIGS. 1-5 is for illustrative purposes only, and that many other sizes and shapes of the adjustable wind chime device 100 are well within the scope of the present disclosure. Although the dimensions of the adjustable wind chime device 100 are important design parameters for user convenience, the adjustable wind chime device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An adjustable wind chime device that provides a user with wind chimes that can have their tone or volume adjusted, the adjustable wind chime device comprising:
a base component;
a plurality of chime components;
a gong component; and
a ball component;
wherein the plurality of chime components and the gong component are secured to the base component via lines; and
further wherein the ball component is positioned underneath the gong component, to allow a user to change sounds emitted from the plurality of chime components and gong component, and silence them with ease.

2. The adjustable wind chime device of claim 1, wherein the base component is configured in a circular shape, with a hollow middle.

3. The adjustable wind chime device of claim 2, wherein the base component comprises an upper portion and a lower portion.

4. The adjustable wind chime device of claim 3, wherein the base component comprises a hanger extending upward from the upper portion and comprising a loop configured to receive a securing means, such as a thumb tack, pushpin, nail, or screw.

5. The adjustable wind chime device of claim 4, wherein the plurality of chime components is configured as cylindrical metal tubes of varying sizes, suspended vertically from the base component.

6. The adjustable wind chime device of claim 5, wherein each chime component of the plurality of chime components is secured to the lower portion of the base component by at least one line secured to its proximate end.

7. The adjustable wind chime device of claim 6, wherein the plurality of chime components are secured to the lower portion in a circular arrangement.

8. The adjustable wind chime device of claim 7, wherein each of the plurality of chime components is hollow and configured to produce an audible noise when struck.

9. The adjustable wind chime device of claim 8, wherein the at least one line includes a first length connected to a separate support structure and to the base component via a swivel.

10. The adjustable wind chime device of claim 9, wherein the gong component is centrally located relative to the plurality of chime components.

11. The adjustable wind chime device of claim 10, wherein the gong component is a disc-shaped piece of material having an upwardly facing surface which comprises a line to attach it to the base component and a downwardly facing surface beneath which the ball component is disposed and secured.

12. The adjustable wind chime device of claim 11, wherein the ball component is secured distally from the gong component, via a small hole drilled into the ball component and a line attached with glue to the ball component.

13. The adjustable wind chime device of claim 12, wherein a second length of line is connected to the gong component and to the underside of the base component, while a third length of line is connected to the gong component and the ball component.

14. An adjustable wind chime device that provides a user with wind chimes that can have their tone or volume adjusted, the adjustable wind chime device comprising:
a base component configured in a circular shape with a hollow middle, and comprising an upper portion and a lower portion;
a plurality of chime components configured as cylindrical metal tubes of varying sizes, suspended vertically from the base component;
a gong component; and
a ball component;
wherein the plurality of chime components and the gong component are secured to the lower portion of the base component in a circular arrangement via at least one line;
wherein the gong component is centrally located relative to the plurality of chime components;
wherein the gong component is a disc-shaped piece of material having an upwardly facing surface which comprises a line to attach it to the base component and a downwardly facing surface beneath which the ball component is disposed and secured;
wherein the ball component is secured distally from the gong component, via a small hole drilled into the ball component and a line attached with glue to the ball component; and
further wherein the ball component is positioned underneath the gong component, to allow a user to change sounds emitted from the plurality of chime components and gong component, and silence them with ease.

15. The adjustable wind chime device of claim 14, wherein the at least one line includes a first length connected to a separate support structure and to the base component via a swivel, a second length of line connected to the gong component and to the underside of the base component, and a third length of line connected to the gong component and the ball component.

16. The adjustable wind chime device of claim 15, wherein the second length of line functions as means for supporting the gong component while allowing rotational and sideways movement of the plurality of chime components in response to the wind.

17. The adjustable wind chime device of claim 16, wherein the second and third lengths of line also function as means for storing rotational energy as the gong component and the ball component rotate.

18. The adjustable wind chime device of claim 14, wherein the gong component is connected to a wind catch.

19. The adjustable wind chime device of claim 14 further comprising a plurality of indicia.

20. A method of adjusting the tone and volume of a set of wind chimes, the method comprising the following steps:
providing an adjustable wind chime device comprising a plurality of chime components and a gong component which are suspended by lines and secured to a base component in a vertical configuration;
drilling a small hole into a ball component;
securing a line via glue to the hole to suspend the ball component under the gong component; and
adjusting the ball component to change the sounds emitted or to silence the chimes.
